(19) United States
(12) Patent Application Publication
(10) Pub. No.: US 2014/0092348 A1
(43) Pub. Date: Apr. 3, 2014

(54) RETARDATION FILM, POLARIZING PLATE, LIQUID CRYSTAL DISPLAY DEVICE, AND METHODS OF PRODUCING RETARDATION FILM AND POLARIZING PLATE

(71) Applicant: FUJIFILM Corporation, Tokyo (JP)

(72) Inventors: Ayako MURAMATSU, Kanagawa (JP); Hiroshi SATO, Kanagawa (JP)

(73) Assignee: FUJIFILM Corporation, Tokyo (JP)

(21) Appl. No.: 14/030,729

(22) Filed: Sep. 18, 2013

(30) Foreign Application Priority Data
Sep. 28, 2012 (JP) 2012-215992
Aug. 30, 2013 (JP) 2013-179006

(51) Int. Cl. G02F 1/13363

(52) U.S. Cl. CPC G02F 1/133636
USPC 349/99; 349/96; 156/238

(57) ABSTRACT

Provided is a retardation film that can be incorporated into a liquid crystal display device having low power consumption. The retardation film includes a support (A) and a rodlike liquid crystalline compound layer (B), which satisfies a particular brightness when the retardation film is incorporated into a liquid crystal device.

### CROSS-REFERENCE TO RELATED APPLICATIONS

The present application claims the benefit of priority from Japanese Patent Application Nos. 215992/2012, filed on Sep. 28, 2012 and 179006/2013, filed on Aug. 30, 2013, the contents of which are herein incorporated by reference in their entirety.

### FIELD OF THE INVENTION

The present invention relates to a retardation film, a polarizing plate, and a liquid crystal display. In particular, the invention relates to a retardation film that is useful as a polarizing plate protective film. The present invention also relates to a polarizing plate including such a retardation film, a birefringence mode liquid crystal display device including the polarizing plate, a method of producing the retardation film, and a method of producing the polarizing plate.

### BACKGROUND ART

Conventionally, the use of a retardation film as a protective film of a polarizing plate of a liquid crystal display device has been investigated (Japanese Patent Laid-Open. No. 2011-215562).

Incidentally, twisted nematic (TN) mode liquid crystal display devices are known to be categorized into an optical rotation mode and a birefringence mode.

FIG. 1 is a schematic diagram illustrating a typical configuration of a conventional TN liquid crystal display device of an optical rotation mode. In the drawing, reference numeral 11 denotes an upper or lower polarizing film, reference numeral 12 denotes a retardation film functioning also as a protective film of a polarizing plate, reference numeral 13 denotes a upper or lower liquid crystal cell substrate, reference numeral 14 denotes the rubbing direction of the liquid crystal cell substrate, reference numeral 15 denotes the absorption axis of the polarizing plate, and reference numeral 16 denotes the slow axis of the liquid crystalline compound layer of the retardation film. Usually, a polarizing plate protective film is disposed on the outside of each protective film 11, and a liquid crystal layer is present between the liquid crystal cell substrates, but they are not shown in FIG. 1. In the optical rotation mode, the rubbing direction 14 of the liquid crystal cell substrate 13 on the surface of the liquid crystal cell on the side adjacent to the polarizing plate 11 is, in general, orthogonal or parallel to the absorption axis 15 of the polarizing plate 11. The absorption axes 15 of the upper polarizing plate 11 and the lower polarizing plate 11 are orthogonal to each other and define angles of approximately 45° and approximately 135′, respectively, relative to an arbitrary side of the film. In addition, in FIG. 1, the slow axis 16 of the liquid crystalline compound layer of the retardation film is approximately parallel to the absorption axis 15 of the polarizing plate.

Since the absorption axes of the polarizing plates define angles of approximately 45° and approximately 135°, respectively, to an arbitrary side of the film in the optical rotation mode, the film cannot be efficiently used in roll-to-roll production. Accordingly, a birefringence mode that allows cutting out such that the absorption axis is in the direction of approximately 0° or 90° to the conveying direction of the film has been investigated.

### SUMMARY OF INVENTION

Unfortunately, the results of investigation by the present inventor demonstrate that the use of the retardation film shown in FIG. 1 in a TN liquid crystal display device of a birefringence mode increases the power consumption. It is an object of the present invention to solve such a problem and to provide a polarizing plate that can be produced at high yield and can reduce power consumption of liquid crystal devices and a retardation film for the polarizing plate.

In order to achieve the object, the present inventor tried to improve the retardation film as a polarizing plate protective film that is used in liquid crystal display device of a birefringence mode. As a result, the inventor has found that a liquid crystal display having low power consumption can be provided by using a rodlike liquid crystalline compound layer in a retardation film, disposing the rodlike liquid crystalline compound layer such that the slow axis defines an angle of 35° to 55° relative to the absorption axis of a polarizing film, and improving the white brightness of the liquid crystal display device when a polarizing plate including the retardation film is used, and the present invention has been accomplished. More specifically, the above-described problems were solved by embodiment <1> below, and preferably by embodiments <2> to <18>.

<1> A retardation film comprising:

a support (A); and

a rodlike liquid crystalline compound layer (B), when two polarizing plates each having the retardation film as a polarizing plate protective film are incorporated into a liquid crystal display device having a TN liquid crystal cell so as to dispose the liquid crystal cell between the polarizing plates, wherein the polarizing plates are arranged such that the retardation films are arranged at the side close to the liquid crystal cell, that the absorbtion axes of the polarizing plates are orthogonal to each other, that the absorption axis of each polarizing film defines an angle of approximately 45° relative to the alignment direction of the liquid crystalline compounds on the surface of the liquid crystal cell at the closer side, that the slow axis of the rodlike liquid crystalline compound layer defines an angle of 45° relative to the absorption axis of the polarizing film, and that the alignment direction of the liquid crystalline compounds defines an angle of 170° to 190° relative to the slow axis of the rodlike liquid crystalline compound layer,

the brightness in a white display mode is 95% or more of the brightness whoa the polarizing plates are arranged in the liquid crystal display such that the transmission axis of each polarizing film is parallel to the alignment direction of the liquid crystalline compounds on the surface of the liquid crystal cell at the closer side.
<2> The retardation film according to <1>, wherein the rodlike liquid crystalline compound layer has a retardation in plane (Re(550)) satisfying 10 nm≦Re(550)≦40 nm at a wavelength of 550 nm.
<3> The retardation film according to <1> or <2>, wherein the rodlike liquid crystalline compound in the rodlike liquid crystalline compound layer is hybrid-aligned.
<4> The retardation film according to <3>, wherein the rodlike liquid crystalline compound has an average tilt angle within a range of 20°≦average tilt angle≦40°.
<5> The retardation film according to any one of <1> to <4>, wherein the support has a thickness of 40 μm or less.
<6> The retardation film according to any one of <1> to <4>, wherein the support has a thickness of 25 μm or less.
<7> The retardation film according to any one of <1> to <6>, wherein the support is a cellulose acylate film or a cycloolefin polymer film.
<8> The retardation film according to any one of <1> to <7>, wherein the rodlike liquid crystalline compound is a rodlike liquid crystalline high-molecular compound.
<9> The retardation film according to any one of <1> to <8>, wherein the rodlike liquid crystalline compound is a polymerizable liquid crystalline compound.
<10> The retardation film according to any one of <1> to <9>, wherein the rodlike liquid crystalline compound layer is prepared by transferring a rodlike liquid crystalline compound layer formed on a tentative support onto the support.
<11> The retardation film according to any one of <1> to <10>, wherein the slow axis of the rodlike liquid crystalline compound layer and the slow axis of the support define an angle of 35° to 55°.
<12> A polarizing plate comprising a retardation film according to any one of <1> to <11> and a polarizing film.
<13> The polarizing plate according to <12>, wherein the slow axis of the support is approximately parallel to the absorption axis of the polarizing film.
<14> The polarizing plate according to <13>, wherein the polarizing plate is produced by roll-to-roll.
<15> A TN liquid crystal display device comprising a retardation film according to any one of <1> to <12> or a polarizing plate according to <13> or <14>.
<16> A TN liquid crystal display, wherein a polarizing plate according to <13> or <14> is disposed such that the absorption axis of the polarizing film defines an angle of approximately 45° relative to the alignment direction of the liquid crystalline compounds on the surface of the liquid crystal cell of is TN mode on the side close to the polarizing film.
<17> A method of producing a retardation film according to any one of <1> to <12>, the method comprising:

forming a rodlike liquid crystalline compound layer on a tentative support; and

transferring the rodlike liquid crystalline compound layer onto a support having a thickness of 40 μm or less.

<18> A method of producing a retardation film according to any one of <1> to <12>, the method comprising:

laminating a support and a rodlike liquid crystalline compound layer by roll-to-roll such that the slow axis of the support and the absorption axis of the polarizing film are approximately parallel to each other and that the slow axis of the rodlike liquid crystalline compound layer and the slow axis of the support define an angle of 35° to 55°.

### Advantageous Effects of Invention

The present invention can provide a polarizing plate that can be incorporated into a liquid crystal display device having low power consumption and a retardation film that is used in the polarizing plate.

### BRIEF DESCRIPTION OF DRAWINGS

FIG. 1 is a schematic diagram illustrating an example of the configuration of a conventional TN liquid crystal display device of an optical rotation mode.

FIG. 2 is a schematic diagram illustrating an example of the TN liquid crystal display device of a birefringent mode in which the retardation film of the present invention is incorporated.

FIG. 3 is a schematic diagram illustrating the concept on the direction of an angle in the present invention.

FIG. 4 is a conceptual diagram illustrating a relationship between the upper polarizing plate and the axis of a liquid crystal cell substrate of the present invention.

FIG. 5 is a schematic diagram illustrating a relationship between the lower polarizing plate and the axis of a liquid crystal cell substrate of the present invention.

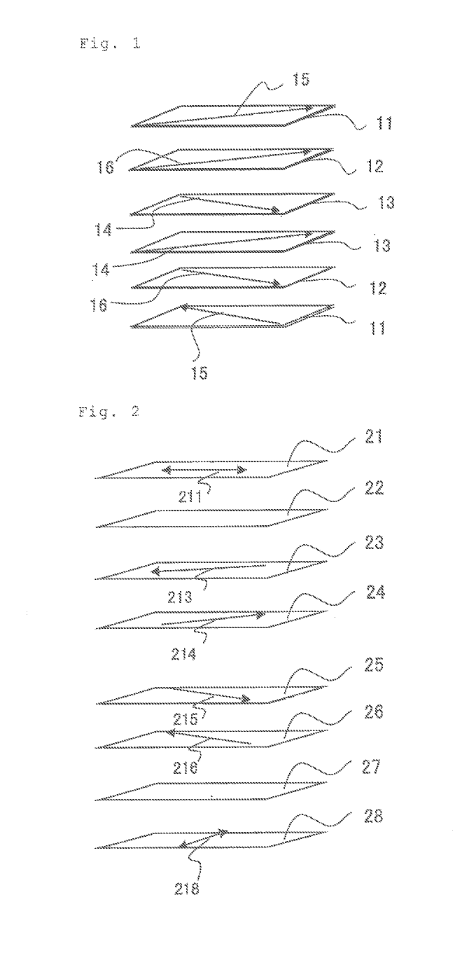

### DESCRIPTION OF EMBODIMENTS

The present invention will now be described in detail. In this description, the numerical range expressed by the wording “a number to another number” means the range that falls between the former number indicating the lowermost limit of the range and the latter number indicating the uppermost limit thereof. First described are the terms used in this description. In addition, throughout the specification, numerical ranges and numerical values should be construed as ones including errors generally acceptable in the field of the invention. In particular, the relationships of optical axes include errors acceptable in the field of the invention throughout the specification. Specifically, the term “approximately” refers to a range of from more than −10° to less than +10°, preferably from more than −5° to less than +5°, and more preferably from more than −3° to less than +3°, from the angle in the strict definition.

Throughout the specification, the terms “parallel” and “orthogonal” each refer to a range within ±5° from the angle in the strict definition. The error from the angle in the strict definition ranges preferably from more than −4° to less than +4° and more preferably from more than −3° to less than +3°.

Throughout the specification, the term “polarizing plate” refers to both a long polarizing plate and a polarizing plate cut into a size to be incorporated into a liquid crystal apparatus (throughout the specification, the term “cut” includes meanings such as “punching” and “cutting out”), unless otherwise specified. Throughout the specification, the term “polarizing film” and the term “polarizing plate” are distinguished from each other, i.e., the term “polarizing plate” is used for a laminate comprising a “polarizing film” and a transparent protective film disposed on at least one surface of the polarizing film for protecting it.

The retardation film includes a support (A) and a rodlike liquid crystalline compound layer (B). Two polarizing plates each having the retardation film as the polarizing plate protective film are incorporated into a liquid crystal display device having a TN liquid crystal cell so as to have the liquid crystal cell between the polarizing plates, wherein the polarizing plates are arranged such that the retardation films are arranged at the side close to the liquid crystal cell, that the absorption axes of the polarizing plates are orthogonal to each other, that the absorption axis of each polarizing film defines an angle of approximately 45° relative to the alignment direction of the liquid crystalline compounds on the surface of the liquid crystal cell at the side close to the polarizing film, that the slow axis of the rodlike liquid crystalline compound layer defines an angle of 45° relative to the absorption axis of the polarizing film, and that the alignment direction of the liquid crystalline compounds defines an angle of 170° to 190° relative to the slow axis of the rodlike liquid crystalline compound layer. The retardation film is characterized in that the brightness in a white display mode in the arrangement described above is 95% or more of the brightness when the polarizing plates are arranged in the liquid crystal display device such that the transmission axis of each polarizing film is parallel to the alignment direction of the liquid crystalline compounds on the surface of the liquid crystal cell at the side close to the polarizing film.

The present invention will now be described with reference to drawings, but is not limited thereto.

FIG. 2 shows an example of the TN liquid crystal display device of a birefringence mode including the retardation film of the present invention, wherein reference numeral 21 denotes the polarizing film of the upper polarizing plate, reference numeral 22 denotes the support of the retardation film of the present invention, reference numeral 23 denotes the rodlike liquid crystalline compound layer of the retardation film of the present invention, reference numeral 24 denotes the upper liquid crystal cell substrate, reference numeral 25 denotes the lower liquid crystal cell substrate, reference numeral 26 denotes the rodlike liquid crystalline compound layer of the retardation film of the present invention, reference numeral 27 denotes the support of the retardation film of the present invention, reference numeral 28 denotes the polarizing film of the lower polarizing plate, reference numeral 211 denotes the absorption axis of the upper polarizing film, reference numeral 213 denotes the slow axis of the rodlike liquid crystalline compound layer, reference numeral 214 denotes the rubbing direction of the upper liquid crystal cell substrate, reference numeral 215 denotes the rubbing direction of the lower liquid crystal cell substrate, reference numeral 216 denotes the slow axis of the rodlike liquid crystalline compound layer, reference numeral number 217 donates transmission axis and reference numeral 218 denotes the absorption axis of lower polarizing film.

In this embodiment, the polarizing film 21 (or 28) is disposed such that the transmission axis (which is the axis orthogonal to the absorption axis) defines an angle of −45° relative to the rubbing direction 214 (or 215) of the liquid crystal cell substrate 24 (or 25), that is, the alignment direction of the liquid crystalline compounds on the surface of the TN liquid crystal cell at the side close to the polarizing film in an angle of −45°. The alignment direction of the liquid crystalline compounds on the surface of the liquid crystal cell at the side close to the polarizing film is usually controlled by the rubbing direction of the liquid crystal cell substrate and may be controlled by another method in the present invention.

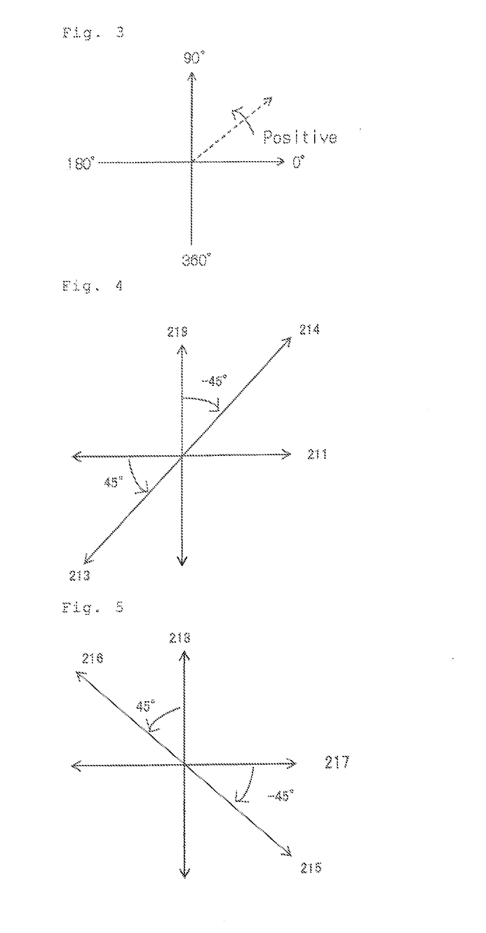

In the specification, the term “angle” may be defined such that when a liquid crystal display device is viewed from the normal direction of the display surface at a viewing side, the lower side of the display surface of the liquid crystal display device is 0° and the counterclockwise direction is positive, for convenience. For example, when FIG. 3 is assumed to show a display surface, the direction indicated by the arrow is positive, and the dashed line arrow indicates an angle of +45°. However, a retardation film or a polarizing plate of the present invention may be not necessarily incorporated into a liquid crystal display device such that the lower side of the display face of the liquid crystal display is in an angle of 0°.

In FIG. 2, when the lower side of the display face of the liquid crystal display device is defined as an angle of 0°, the absorption axis 211 of the upper polarizing plate indicates an angle of 0°, the slow axis 213 of the rodlike liquid crystalline compound layer 23 of the upper retardation film indicates an angle of 225°, and the rubbing direction 214 of the upper liquid crystal cell substrate 24 indicates an angle of 45°. That is, the relationships of these axes with the rubbing direction are as shown in FIG. 4. In FIG. 4, reference numeral 219 denotes the transmission axis of the polarizing plate. As obvious from FIG. 4, the polarizing film is disposed such that the transmission axis 219 defines an angle of −45° relative to the rubbing direction 214 of the liquid crystal cell substrate and such that the absorption axis 211 defines an angle of +45° relative to the slow axis 213 of the rodlike liquid crystalline compound layer. That is, in the embodiment, the alignment direction of the liquid crystalline compounds and the slow axis of the rodlike liquid crystalline compound layer define an angle of 180°.

The relationship between the lower polarizing plate and the liquid crystal cell shown in FIG. 2 is as shown in FIG. 5 and is the same as that when the relationship shown in FIG. 4 is rotated by −90°. That is, the relationships in axes and angles are equivalent to those shown in FIG. 4.

In FIG. 2, the slow axis of the rodlike liquid crystalline compound layer defines an angle of +45° relative to the absorption axis of the polarizing film, but the angle defined by the slow axis of the rodlike liquid crystalline compound layer and the absorption axis of the polarizing film is not limited to 45° and can be in a range of 35° to 55°. The angle defined by the slow axis of the rodlike liquid crystalline compound layer and the absorption axis of the polarizing film is preferably in a range of 40° to 50° and more preferably 42° to 48° and is most preferably 45°. Accordingly, the angle defined by the alignment direction of the liquid crystalline compounds and the slow axis of the rodlike liquid crystalline compound layer is in the range of 170° to 190°.

In the present invention, the brightness in a white display mode when the polarizing plate is disposed as described above is adjusted to be 95° or more, preferably 97% or more, of the brightness in the liquid crystal display when the alignment direction of the liquid crystalline compounds on the surface of the liquid crystal cell at the side close to each polarizing film is parallel to the transmission axis of the polarizing film, i.e., the brightness when the polarizing plate is incorporated into a liquid crystal display using an optical rotation mode. Such, an improvement of the brightness in white display mode allows a reduction in power consumption of the liquid crystal display.

The improvement of the brightness in a white display mode can be achieved by arbitrarily selecting (2) the control of the retardation in plane (Re) value of the retardation film within a predetermined range, (3) the hybrid alignment of the rodlike liquid crystalline compound, (4) the control of the average tilt angle of the rodlike liquid crystalline compound of the rodlike liquid crystalline compound layer within a range of 20′≦average tilt angle≦40°, and/or) (5) a reduction in the thickness, in addition to by using (1) the retardation film comprising a rodlike liquid crystalline compound layer such that the slow axis of the rodlike liquid crystalline compound layer defines an angle of +45° relative to the absorption axis of the polarizing film.

### <Retardation Film>

The retardation film of the present invention includes a support and a rodlike liquid crystalline compound layer. High brightness in a white display mode can be achieved with the rodlike liquid crystalline compound layer in the retardation film.

### Rodlike Liquid Crystalline Compound Layer

The rodlike liquid crystalline compound layer is mainly composed of a rodlike liquid crystalline compound. In the rodlike liquid crystalline compound layer of the present invention, the alignment state is fixed. Even if the liquid crystallinity is lost in the fixed state, the rodlike liquid crystalline compound layer is encompassed in the scope of the present invention.

The rodlike liquid crystalline compound layer mainly composed of a rodlike liquid crystalline compound in the present invention may contain other components, preferably, a rodlike liquid crystalline high-molecular compound and a polymerizable liquid crystalline compound, for example. The rodlike liquid crystalline compound layer may contain a single rodlike liquid crystalline compound and preferably contains two or more rodlike liquid crystalline compounds.

In the present invention, the rodlike liquid crystalline compound in the rodlike liquid crystalline compound layer may be horizontally aligned and is preferably hybrid-aligned. The hybrid alignment can further improve the brightness in a white display mode.

The hybrid alignment can be achieved by, for example, using two or more rodlike liquid crystalline high-molecular compounds or polymerizable liquid crystalline compounds. Alternatively, the hybrid alignment can be achieved by independently controlling the director of the liquid crystals close to the air interface and the director of the liquid crystals close to the substrate using alignment controllers for air interface and/or alignment controllers for a substrate.

The rodlike liquid crystalline compound layer in the present invention preferably has an average tilt angle within a range of 20°≦average tilt angle≦40°. Within this range, grayscale inversion when viewed from the lower side can be effectively inhibited. In birefringence mode, since the grayscale inversion when viewed from the lower side is apt to be problematic, the present invention effectively inhibiting such grayscale inversion has a great significance. Such an average tilt angle can also improve the front face contrast. In the present invention, the average tilt angle is further preferably within range of 20°≦average tilt angle≦35°.

The average tilt angle in the present invention can be measured with KOBRA 21ADH or KOBRA WR (available from Oji Scientific Instruments).

### Rodlike Liquid Crystalline High-Molecular Compound

The rodlike liquid crystalline high-molecular compound may be a homeotropically aligned liquid crystalline polymer or a homogeneously aligned liquid crystalline polymer and is preferably a mixture thereof. The details of the homeotropically aligned liquid crystalline polymer and the homogeneously aligned liquid crystalline polymer are described in Japanese Patent Laid-Open No. Hei 6-347742, which is incorporated herein by reference. The use of two or more of such rodlike liquid crystalline high-molecular compounds can achieve hybrid alignment within an average tilt angle range of 20° to 40 °.

The alignment of a polymer can be determined by forming a liquid crystalline polymer layer on a substrate and investigating whether the liquid crystalline polymer in a liquid crystal state aligns homeotropically or homogeneously. Any substrate can be used in this determination, and examples thereof include glass substrates (e.g., soda glass, potash glass, borosilicate glass, and optical glass such as crown glass and flint glass) and plastic films and sheets showing thermal resistance at a liquid crystal temperature of the liquid crystalline polymer to be investigated, such as polyethylene terephthalate, polyethylene naphthalate, polyphenylene oxide, polyimides, polyamide-imides, polyether imides, polyamides, polyether ketones, polyether ether ketones, polyketone sulfides, and polyether sulfones. These substrates are used after cleaning the surfaces with, for example, an acid, an alcohol, or a detergent, but are not subjected to surface treatment such as silicon treatment. A film of a polymer is formed on an appropriate substrate and is treated with heat at a liquid crystal temperature. A polymer that forms a homeotropically aligned film on any substrate of the above-mentioned substrates is defined as a homeotropically aligned polymer, whereas a polymer that forms a homogeneously aligned film on every substrate, i.e., not having homeotropic alignment properties, is defined as a homogeneously aligned polymer. In this regard, same polymers homeotropically align at specific temperatures near the transition temperature between the respective liquid crystal phase and the isotropic phase. Accordingly, the heat treatment is usually performed at a temperature 15° preferably 20° C. lower than the transition temperature between the liquid crystal phase and the isotropic phase.

Any liquid crystalline polymer can be used which can function as both a homeotropically aligned polymer and a homogeneously aligned polymer. Examples of such a polymer include main-chain liquid crystalline polymers such as polyesters, polyamides, polycarbonates, and polyesterimides; and side-chain liquid crystalline polymers such as polyacrylates, polymethacrylates, polymalonstes, and polysiloxanes. In particular, polyesters are preferred from the points of the ease of synthesis, the alignment properties, the glass transition temperature, and other factors. The polyesters may have any structural units, and preferable examples of the units include units (a) derived from dicarboxylic acids (hereinafter, referred to as dicarboxylate units), units (b) derived from diols (hereinafter, referred to as diol units), and units (c) derived from oxycarboxylic acids having a carboxyl group and a hydroxy group in one unit (hereinafter, referred to as oxycarboxylate units). In addition, units derived from compounds having structural units including asymmetric carbons (optically active or racemic compounds) can be used. Most of the polymers containing optically active units have chiral nematic liquid crystal phases (twisted nematic phases or cholesteric phases), whereas polymers not containing optically active units have nematic liquid crystal phases. Polyesters have a structure of an (a)+(b) type, an (a)+(b)+(c) type, or an alone (c) type.

Examples of the dicarboxylate unit (a) include the following structural units:

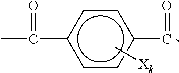

(wherein, X represents hydrogen, a halogen such as chlorine or bromine, an alkyl group having 1 to 4 carbon atoms (e.g., a methyl group, an ethyl group, a propyl group, an isopropyl group, a butyl group, or a t-butyl group), an alkoxy group (e.g., a methoxy group, an ethoxy group, a propoxy group, or a butoxy group), or a phenyl group; and k denotes an integer of 0 to 2, the same applies hereinafter),

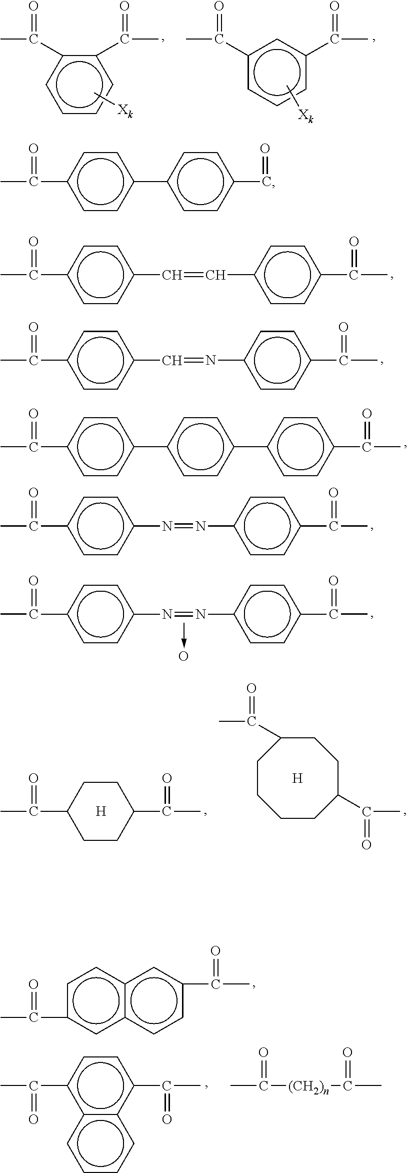

n is an integer of 1 to 12.

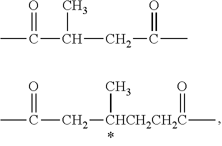

(The mark * indicates an optically active carbon, the same applies hereinafter).

Examples of the diol unit (b) include the following structural units:

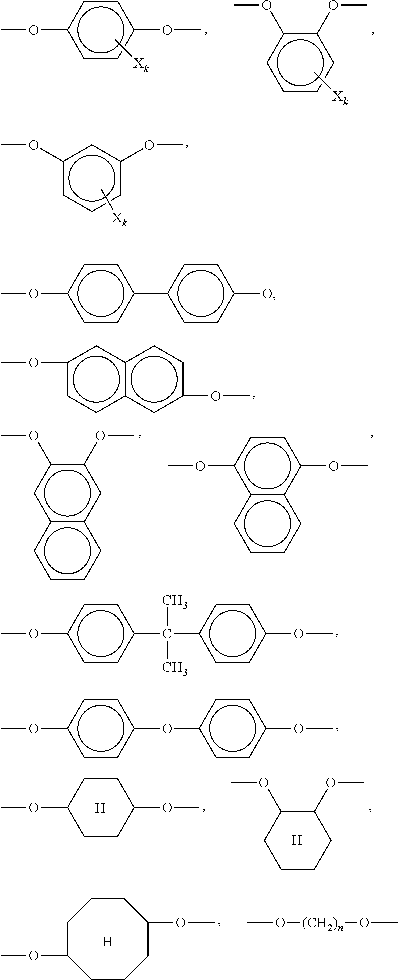

n is an integer of 1 to 12.

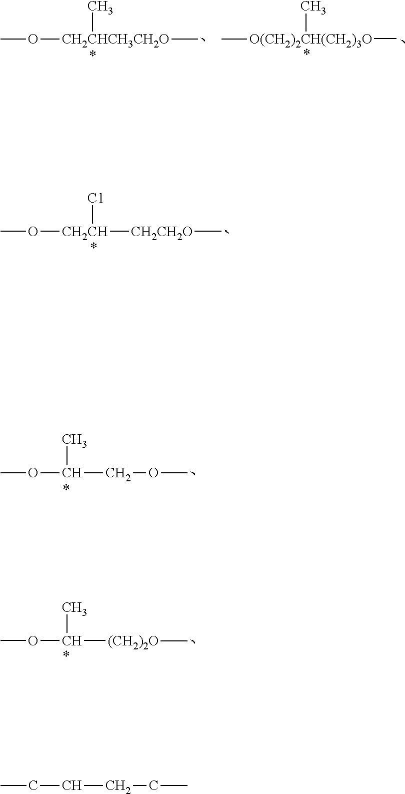

Examples of the oxycarboxylate unit (C) include the following structural units:

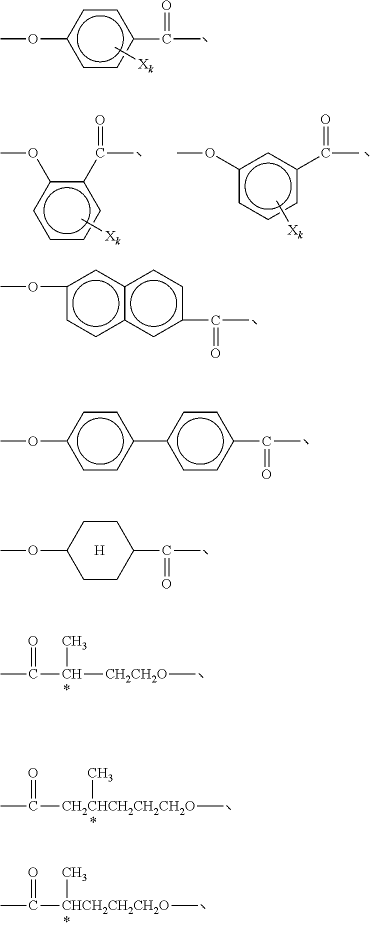

Homeotropically aligned polymers can be distinguished from homogeneously aligned polymers by the method described above. Typical polymers having homeotropic alignment are the above-mentioned polyester containing aromatic units including alkyl groups having 3 or more, preferably 3 to 12, carbon atoms so the substituted structural units or additional structural units of a part of structural units or as substituents or a part of substituents; and polyesters having structural units containing aromatic units including fluorine or fluorine-containing substituents as substituents or a part of substituents.

Examples of the structural units being the aromatic units including alkyl groups having 3 or more carbon atoms as substituents or a part of substituents include the following structural units (in the following formulae, R denotes an alkyl group having 3 to 12 carbon atoms):

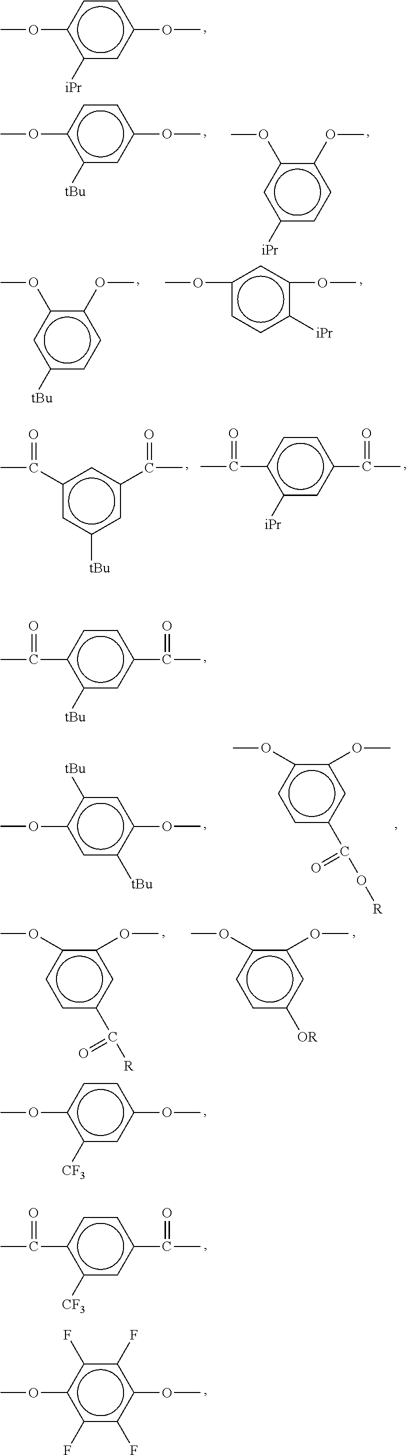

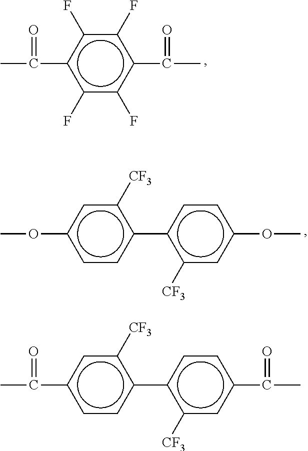

In order to fix the alignment structure of the liquid crystalline polymer composition of the present invention, it is preferable to use a polymer composition that is in a glassy state without crystallization at a lower temperature region than the transition temperature of the liquid crystal layer. For the fixation of the liquid crystal structure of a composition, polymer molecules are once aligned at the liquid crystal temperature, and then are cooled to be fixed. The use of a composition having a crystal phase, however, has a risk of destruction of the formed aligned state. For example, in the case of the polyester-based polymer exemplified above, ortho-substituted aromatic units are preferably used as the structural units for inhibiting crystallization, and polyester-based polymers containing such units are preferred examples. The term “ortho-substituted aromatic unit” used herein refers to a structural unit of which ortho-position is used for bonding forming the main chain. At least one of the homeotropically aligned polymers and the homogeneously aligned polymers forming a composition preferably contain such structural units for maintaining the glassy state of the composition without causing crystallization at a lower temperature region than the transition temperature of the liquid crystal phase. Specific examples of the ortho-substituted aromatic unit include catechol units, salicylate units, phthalate units, and these groups having substituents on the benzene rings thereof as shown below:

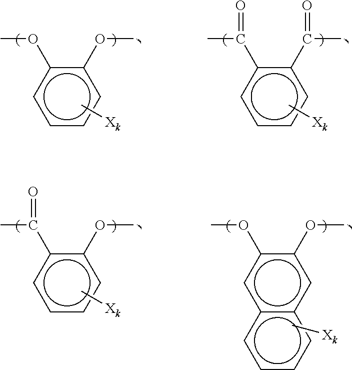

Among these compounds, most preferable examples are as follows:

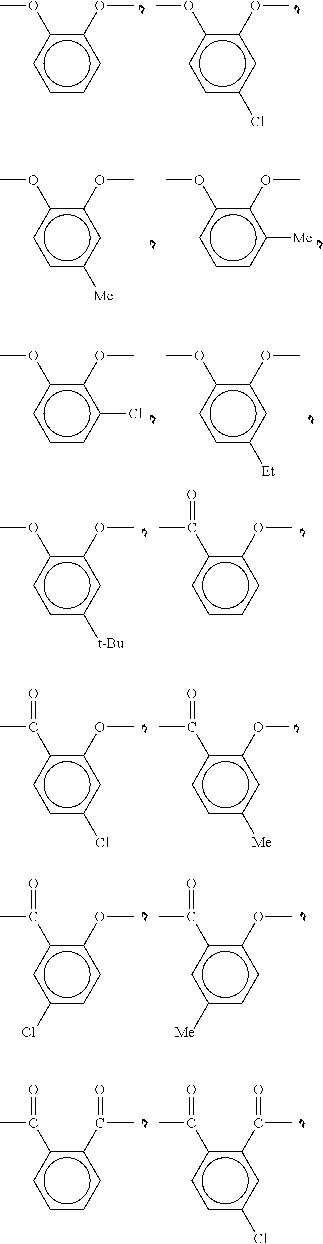

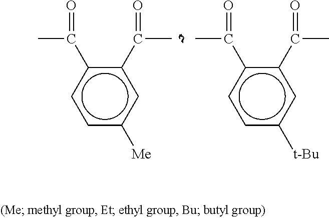

Specific examples of the homeotropically aligned polymer constituting the liquid crystal composition of the present invention include the following polyesters (in the following formulae k, l, and m each merely represent a molar ratio in the composition end satisfy k=l+m and l/m=100/0 to 20/80 preferably 95/5 to 30/70).

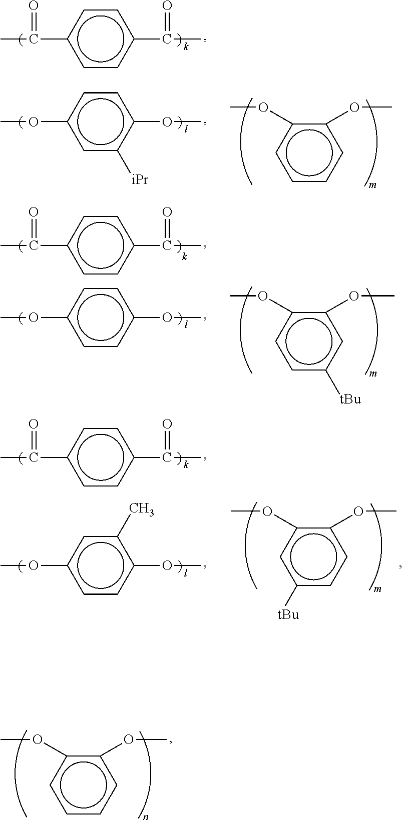

(in the following formulae, k, l, m, and n each merely represent a molar ratio in the composition and satisfy k=l+m+n, l/m=98/2 to 20/80 preferably 95/5 to 30/70, and l/n=98/2 to 20/30 preferably 95/5 to 30/70).

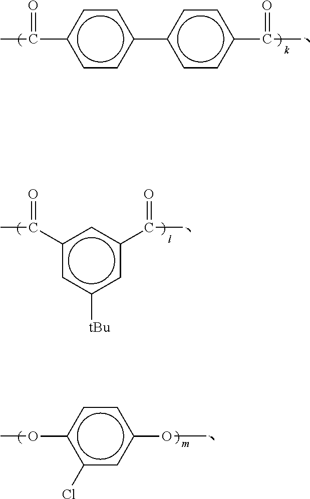

(in the following formulae, k, l, and m each merely represent a molar ratio in the composition and satisfy k+l=m and k/l=98/2 to 20/80 preferably 95/5 to 30/70).

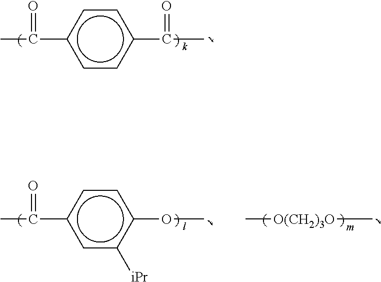

(in the following formulae, k, l, and m each merely represent a molar ratio in the composition and satisfy k/l=98/2 to 20/80 preferably 95/5 to 30/70 and l/m=98/2 to 20/80 preferably 95/5 to 30/70; and m represents an integer of 2 to 12).

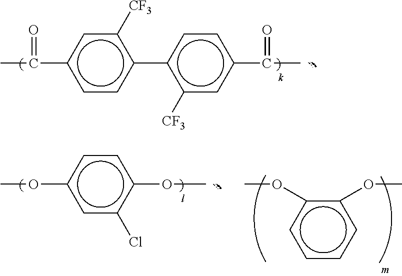

in the following formulae, k, l, and m each merely represent a molar ratio in the composition and satisfy k=l+m and l/m=98/2 to 20/80 preferably 95/5 to 30/70).

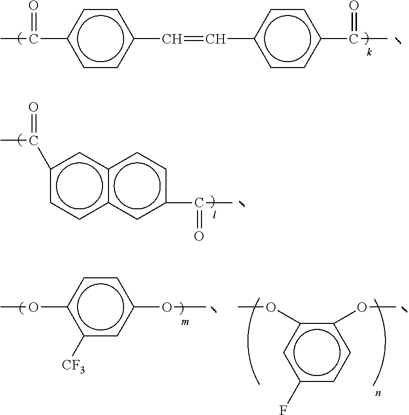

(in the following formulae, k, l, m, and n each merely represent a molar ratio in the composition and satisfy k+l=m+n, k/l=100/0 to 0/100 preferably 95/5 to 5/95, and m/n=98/2 to 20/80 preferably 95/5 to 30/70).

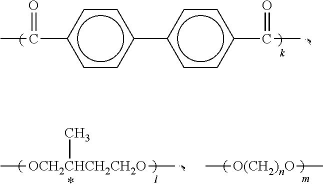

(in the following formulae, k, l, and m each merely represent molar ratio in the composition and satisfy k=l+m and l/m=100/0 to 0/100 preferably 98/2 to 2/98; and n represents an integer of 2 to 12).

Examples of the homogeneously aligned polymer include the following polymers:

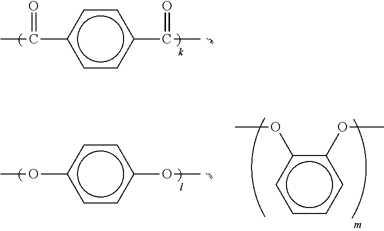

(in the following formulae, k, l, and m each merely represent a molar ratio in the composition and satisfy k=l+m and l/m=80/20 to 20/80 preferably 75/25 to 25/75).

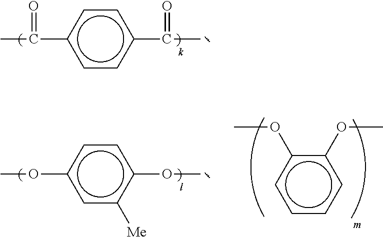

(in the following formulae, k, l, and m each merely represent a molar ratio in the composition and satisfy k=l+m and l/m=80/20 to 20/80 preferably 75/25 to 25/75).

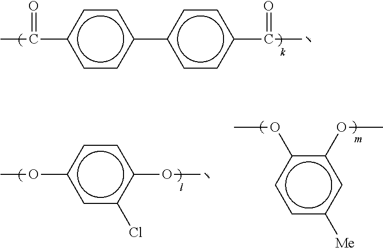

(in the following formulae, k, l, and m each merely represent a molar ratio in the composition and satisfy k=l+m and l/m=80/20 to 20/80 preferably 75/25 to 25/75).

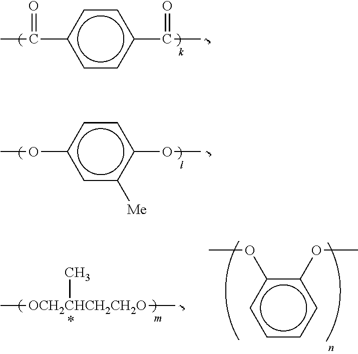

(in the following formulae, k, l, m, and n each merely represent a molar ratio in the composition and satisfy k=l+m+n, l/m=80/20 to 20/80 preferably 75/25 to 25/75, and l/n=80/20 to 20/80 preferably 75/25 to 25/75).

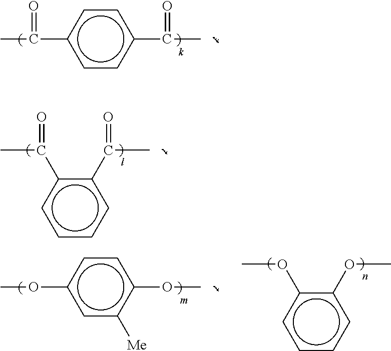

(in the following formulae, k, l, m, and n each merely represent a molar ratio in the composition and satisfy k+l=m+n, k/l=80/20 to 20/80 preferably 75/25 to 25/75, and m/n=80/20 to 20/80 preferably 75/25 to 25/75).

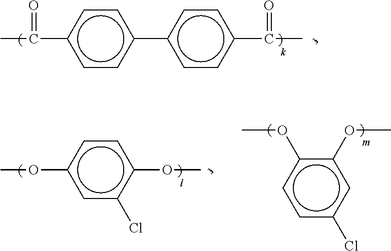

(in the following formulae, k, l, and m each merely represent a molar ratio in the composition and satisfy k=l+m and l/m=80/20 to 20/80 preferably 75/25 to 25/75).

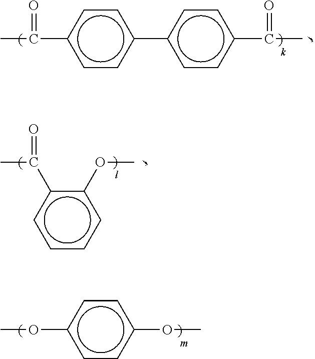

(in the following formulae, k, l, and m each merely represent a molar ratio in the composition and satisfy k/l=80/20 to 20/80 preferably 75/25 to 25/75 and l/m=80/20 to 20/80 preferably 75/25 to 25/75).

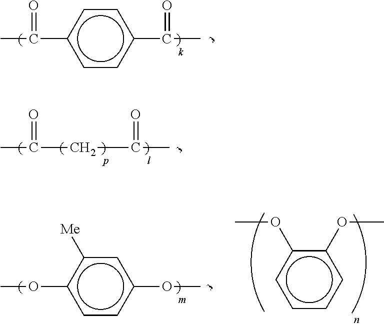

(in the following formulae, k, l, m, and n each merely represent a molar ratio in the composition and satisfy k+l=m+n, k/l=80/20 to 20/80 preferably 75/25 to 25/75, and m/n=80/20 to 20/80 preferably 75/25 to 25/75; and p represents an integer of 2 to 12).

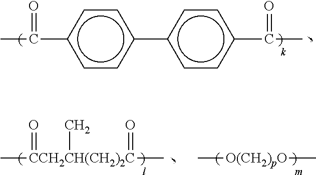

(in the following formulae, k, l, and m each merely represent a molar ratio in the composition and satisfy k+l=m and k/l=80/20 to 20/80 preferably 75/25 to 25/75; and p represents an integer of 2 to 12).

These polymer molecules usually have a logarithmic viscosity within a range of 0.05 to 3.0, more preferably 0.07 to 2.0, in various solvents, e.g., in a phenol/tetrachloroethane (60/40 (weight ratio)) solvent mixture at 30° C. A polymer having a logarithmic viscosity of lower than 0.05 leads to low strength of the resulting polymer liquid crystals, whereas a polymer having a logarithmic viscosity higher than 3.0 causes problems, such as a reduction in alignment and an increase in time necessary for alignment, due to the high viscosity during the liquid crystal formation.

### Polymerizable Liquid Crystalline Compound

The polymerizable liquid crystalline is not limited as far as it is a polymerizable rodlike liquid crystalline compound having a polymerizable group and is preferably (meth)acrylate. Only two polymerizable liquid crystalline compounds may be used, and the use of two or more polymerizable liquid crystalline compounds is preferred. The details of the polymerizable liquid crystalline compound are described in Japanese Patent Laid-Open No. 2001-55573, which is incorporated herein by reference. The use of two or more of such polymerizable liquid crystalline compounds can achieve hybrid alignment within an average tilt angle range of 20° to 40°.

Specifically, the polymerizable liquid crystalline compounds are preferably compounds represented by Formulae (1) and (2):

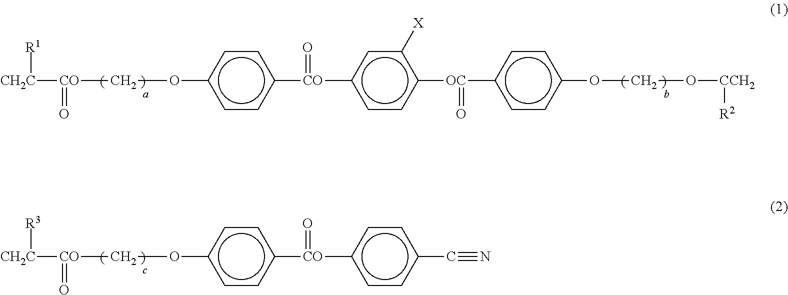

(in Formulae (1) and (2), R¹, R² and R³ each independently represent hydrogen or a methyl group; X represents one selected from the group consisting of hydrogen, chlorine, bromine, iodine, alkyl groups having 1 to 4 carbon atoms, a methoxy group, a cyano group, and a nitro group; and a, b, and c each represent an integer of 2 to 12).

In Formula (1), the lengths a and b of alkyl chains each serving as a spacer between a (meth)acryloyoxy group and an aromatic ring is 2 to 12, preferably 4 to 10, and more preferably 6 to 9. A compound in which a and b are each 0, i.e., a compound in which a (meth)acryloyloxy group and an aromatic ring are directly bonded to each other, and a compound in which a and b are each 1 are readily hydrolyzed, have low stability, and also have a risk of high crystallinity of the compounds themselves. A compound in which a and b are each larger than 13 may decrease the isotropic transition temperature (TI). If a and b are outside the above-mentioned range, the temperature range in which the compound (1) shows liquid crystallinity is disadvantageously narrowed. X in Formula (1) may be any of hydrogen, chlorine, bromine, iodine, alkyl groups having 1 to 4 carbon atoms, a methoxy group, a cyano group, and a nitro group and is preferably chlorine or a methyl group. The compound represented by Formula (2) does not generally show liquid crystallinity by itself but shows liquid crystallinity as a composition with a compound represented by Formula (1). In light of the compatibility with a compound represented by Formula (1), the alkyl chain length c of the compound represented by Formula (2) is 2 to 12, preferably 4 to 10, and more preferably 6 to 9. In Formulae (1) and (2), R¹, R², and R³ each independently represent a hydrogen atom or a methyl group, and, desirably, R¹, R², and R³ are all hydrogen atoms because of a wide temperature range showing a liquid crystal phase.

The liquid crystal composition of the present invention preferably contains a compound represented by Formula (1) and a compound represented by Formula (2). The optimum weight ratio of the compound represented by Formula (1) to the compound represented by Formula (2) in this liquid crystal composition varies depending on the characteristics of the liquid crystal film to be produced, the type of each compound, e.g., the alkyl chain lengths (a, b, and c) in Formulae (1) and (2), and other factors. In general, the ratio of (a compound represented by Formula (1)):(a compound represented by Formula (2)) is within a range of 99:1 to 50:50, preferably 95:5 to 60:40, more preferably 90:10 to 65:35, and most preferably 85:15 to 70:30. In a composition having a ratio of higher than 99 of a compound represented by Formula (1) to a compound represented by Formula (2), the solidification of the film at a liquid crystal state may be difficult due to the ease of crystallization caused by the compound represented by Formula (1). In a composition having a ratio of less than 1, i.e., in a case of the amount of the compound represented by Formula (1) is less than 50% by weight of the total amount of the compound represented by Formula (1) and the compound represented by Formula (2), the isotropic transition temperature (TI) of the composition is decreased, and the temperature range in which a liquid crystal state can be maintained may be significantly narrowed, resulting in, for example, a risk of causing a problem such as a loss of the process margin. In a photocurable liquid crystal composition of the present invention, a plurality of compounds represented by Formula (1) and/or compounds represented by Formula (2) having different alkyl chain lengths (a, b, and c) in Formulae (1) and (2) can be use. Even in this case, the weight ratio of the compounds represented by Formula (1) to the compounds represented by Formula (2) is as described above.

### Retardation

The rodlike liquid crystalline compound layer preferably has a retardation in plane (Re(550)) within a range of 10 nm≦Re(550)≦40 nm at a wavelength of 550 nm. Such a retardation value can improve the brightness in a white display mode.

The range of the retardation is preferably 15 nm≦Re(550)≦35 nm. Such a range has a tendency of further improving the brightness in a white display mode.

The Re(550) can be controlled within the range using a retardation controlling agent or by controlling the thickness of the rodlike liquid crystalline compound layer.

The rodlike liquid crystalline compound layer in the present invention preferably has a thickness of 1 μm to 2 μm and more preferably 1.2 μm to 1.5 μm.

### Rodlike Liquid Crystalline Compound Layer

The rodlike liquid crystalline compound layer in the present invention is usually formed using a composition containing a rodlike liquid crystalline compound. The composition containing a rodlike liquid crystalline compound may further contain other components. Specific examples of the additional component include alignment controllers for air interface, repelling inhibitors, polymerization initiators, and polymerizable monomers. Details of these components are described in paragraph 0019 to 0021 of Japanese Patent Laid-Open No. 2007-171369, which is incorporated herein by reference. Compounds for preparing a composition containing a rodlike liquid crystalline high-molecular compound are described in paragraphs 0084 to 0112 of Japanese Patent Laid-Open No. Hei 6-34772, which is incorporated herein by reference. Preparation of a composition containing a polymer table liquid crystalline compound is described in a paragraph 0011 of Japanese Patent Laid-Open No. 2001-55573, which is incorporated herein by reference.

### Support

Any support that can hold a rodlike liquid crystalline compound layer can be used in the retardation film of the present invention, and a variety of known supports can be used. Specifically, usable supports are described in paragraphs 0041 to 0056 of Japanese Patent Laid-Open No. 2007-171369, which is incorporated herein by reference. Examples of the support in the present invention include cellulose acylate films and cycloolefin polymer films, and cellulose acylate films are more preferred.

The support in the present invention preferably has a thickness of 40 μm or less and more preferably 25 μm or less. Such a thin support can reduce the size and manufacturing costs of a polarizing plate. Although the support does not have a specific lower limit on the thickness, the thickness is, for example, 10 μm or more.

### <Method of Producing Retardation Film>

The retardation film of the present invention can be produced by a known method. For example, the retardation film is formed by forming an alignment film on a surface of a support applying (usually coating) a composition containing a rodlike liquid crystalline compound and other components onto the surface of the alignment film, and fixing the rodlike liquid crystalline compound by curing. Details of the alignment film are described in a paragraph 0039 of Japanese Patent Laid-Open No. 2001-55573, which is incorporated herein by reference. In addition, in a preferred embodiment of the method of producing the retardation film of the present invention, a rodlike liquid crystalline compound layer is formed on a support, and the rodlike liquid crystalline compound layer is transferred onto another support. In more specific, a rodlike liquid crystalline compound layer is aged on a tentative heat-resistant support at high temperature so as to have a homogenous alignment and then transferred onto another support having desired properties. This prevents alignment defects.

### Transfer

A method of forming a rodlike liquid crystalline compound layer by transfer will now be described. In order to reduce the thickness of a support, a rodlike liquid crystalline compound layer may be transferred onto a film for tentatively supporting the layer before the compound layer formed on a support having an alignment film is placed on a support different from the support having an alignment film. As a method for the transfer, for example, as described in Japanese Patent Laid-Open Nos. Hei 4-57017 and Hei 5-333313, only a rodlike liquid crystalline compound layer can be transferred by laminating the rodlike liquid crystalline compound layer on a support different from a support having an alignment film with an adhesive or a bonding agent, optionally curing the adhesive or the bonding agent, and detaching the support having an alignment film from the laminate.

Any optical-grade adhesive or bonding agent can be used for the transfer. Examples thereof include acrylic adhesives, epoxy resins, ethylene-vinyl acetate copolymers, rubber, polyurethanes, and mixtures thereof and reactive adhesives such as heat-curable, photocurable, and electron beam-curable adhesives. Since the reaction (curing) conditions of the reactive adhesives vary depending on the components constituting the adhesives and the conditions such as viscosity and reaction temperature, conditions suitable for each case should be selected. For example, in a photocurable adhesive, the same light source and exposure dose as in the fixation of a liquid crystal composition with a photoreaction initiator described below can be used, and in an electron beam-curable adhesive, the acceleration voltage is usually 10 to 200 kV and preferably 20 to 100 kV.

Other methods of forming the rodlike liquid crystalline compound layer are described in paragraphs 0067 to 0077 of Japanese Patent Laid-Open No. 2008-145836, which is incorporated herein by reference.

### Polarizing Plate

The retardation film of the present invention is used as a protective film for the polarizing plate. That is, the polarizing plate of the present invention has a structure including a polarizing film and a retardation film disposed on at least one surface of the polarizing film.

Any polarizing film can be used in the present invention. The polarizing film may be any one of iodine polarizing films, dye polarizing films including dichroic dyes, and polyene polarizing films. The iodine polarizing film and the dye polarizing film are generally produced with polyvinyl alcohol films. The absorption axis of the polarizing film corresponds to the stretching direction of the film; therefore, a polarizing film stretched an the vertical direction (conveying direction) has an absorption axis parallel to the longitudinal direction, while a polarizing film stretched in the horizontal direction (direction orthogonal to the conveying direction) has an absorption axis orthogonal to the longitudinal direction.

The other surface of the polarizing film is also preferably provided with a protective film. In the polarizing film incorporated into a liquid crystal display, in general, the polarizing plate protective film disposed at the side close to the liquid crystal cell is the retardation film of the present invention, and the protective film disposed on the outside of the polarizing film is another protective film, which may be any film such as a cellulose acylate film, a cyclic olefin polymer film, a polyvinyl alcohol film, a polypropylene film, a polycarbonate film, a norbornene film, an acrylic film, or a PET film.

A preferred method of producing the polarizing plate includes a step of continuously laminating two long protective films and a to polarizing film. The long polarizing plate is cut into a size corresponding to the size of an image display apparatus to which the polarizing plate is applied.

In the retardation film of the present invention, the support can be disposed such that the slow axis is approximately parallel to the absorbtion axis of the polarizing film. That is, the support is normally formed into a rolled state on an industrial scale. In the present invention, since the polarizing plate is incorporated into a liquid crystal display of a birefringence mode, the polarizing plate can be cut out such that the absorption axis of the polarizing plate defines an angle of 0° or 90° relative to the conveying direction of the film. Accordingly, even if the slow axis of the support is approximately parallel to the absorption axis of the polarizing film, the polarizing plate can be efficiently produced by roll-to-roll. In this case, the rodlike liquid crystalline compound layer of the present invention is formed such that the slow axis defines an angle of 35° to 55° relative to the slow axis of the support. Such a rodlike liquid crystalline compound layer can be formed by controlling the rubbing direction of the alignment film or by transfer.

### Method of Producing Polarizing Plate

The polarizing plate of the present invention can be produced by a method including transferring a separately formed rodlike liquid crystalline compound layer onto a moving support (long polymer film) and laminating a long polarizing film having the transmission axis in the width direction on the rodlike liquid crystalline compound layer by roll-to-roll. The polarizing plate can also be produced by a method including forming an alignment film on a moving support (long polymer film), subjecting the alignment film to continuous rubbing treatment in the direction oblique by 35° to 55° relative to the film-conveying direction, applying a composition mainly composed of a rodlike liquid crystalline compound onto the alignment film to form a coating layer, exposing the entire face of the rodlike liquid crystalline compound layer to light to fix the alignment state of the rodlike liquid crystalline compound to form an optically anisotropic layer, and laminating the layer with a long polarizing film having the transmission axis in the width direction by roll-to-roll.

These methods allows continuous production of polarizing plates and therefore reduce the manufacturing costs compared to those in conventional methods. If the rubbing direction is within an angle of 35° to 55° relative to the film-conveying direction, the resulting polarizing plate in a rolled state is not required to be obliquely punched out, and the manufacturing cost of the polarizing plate can be reduced.

### Liquid Crystal Cell

The liquid crystal cell is a TN liquid crystal cell twist-aligned at a twist angle of approximately 90° and at least includes a pair of substrates in which an electrode constituting pixels is provided on at least one of the inner sides and a liquid crystal layer twist-aligned at a twist angle of 90° disposed between the pair of substrates. Such a twist angle of 90° advantageously provides high front face contrast.

The liquid crystal display of the present invention is of a birefringence mode. In an embodiment of the birefringence mode, the rubbing direction of a liquid crystal cell substrate and the absorption axis of a polarizer define an angle of approximately 45° or approximately 135°.

Details of the TN mode are described in Japanese Patent Laid-Open No. Hei 6-214116, U.S. Pat. Nos. 5,503,679 and 5,646,703, and German Patent No. 3911620A1. Optical compensation sheets for a liquid crystal cell of an IPS mode or an FLC mode are described in Japanese Patent Laid-Open No. Hei 10-54982. The contents of these documents are incorporated herein by reference.

In this description, Re(λ) and Rth(λ) are retardation (nm) in plane and retardation (nm) along the thickness direction, respectively, at a wavelength of λ. Throughout the specification, the wavelength λ is 550 nm unless otherwise specified. Re(λ) is measured by applying light having a wavelength of λ nm to a film is the normal direction of the film, using KOBRA 21ADH or WR (by Oji Scientific Instruments). The selection of the measurement wavelength may be conducted according to the manual-exchange of the wavelength-selective-filter or according to exchange of the measurement value by the program.

When a film to be analyzed is expressed by monoaxial or biaxial index ellipsoid, Rth(λ) of the film is calculated as follows.

Rth(λ) is calculated by KOBRA 21ADH or WR on the basis of the six Re (λ) values which are measured for incoming light of a wavelength λ nm in six directions which are decided by a 10° step rotation from 0° to 50° with respect to the normal direction of a sample film using an in-plane slow axis, which is decided by KOBRA 21ADH, as an inclination axis (a rotation axis; defined in an arbitrary in-plane direction if the film has no slow axis in plane), a value of hypothetical mean refractive index, and a value entered as a thickness value of the film.

In the above, when the film to be analyzed has a direction in which the retardation value is zero at a certain inclination angle, around the in-plane slow axis from the normal direction as the rotation axis, then the retardation value at the inclination angle larger then the inclination angle to give a zero retardation is changed to negative data, and then the Rth(λ) of the film is calculated by KOBRA 21ADH or WR.

Around the slow axis as the inclination angle (rotation angle) of the film (when the film does not haven slow axis, than its rotation axis may be in any in-plane direction of the film), the retardation values are measured in any desired inclined two directions, and based on the data, and the estimated value of the mean refractive index and the inputted film thickness value, Rth may be calculated according to formulae (1) and (2):

$$Re ( θ ) = [ nx - \frac{ny \times nz}{\sqrt{\begin{matrix}{( ny sin ( {sin}^{- 1} ( \frac{sin ( - θ )}{nx} ) ) )}^{2} + \\ {( nz cos ( {sin}^{- 1} ( \frac{sin ( - θ )}{nx} ) ) )}^{2}\end{matrix}}} ] \times \frac{d}{cos ( {sin}^{- 1} ( \frac{sin ( - θ )}{nx} ) )} \qquad ( 1 )$$

Re(θ) represents a retardation value in the direction inclined by an angle θ from the normal direction; nx represents a refractive index in the in-plane slow axis direction; ny represents a refractive index in the in-plane direction perpendicular to nx; and nz represents a refractive index in the direction perpendicular to nx and ny. And “d” is a thickness of the film.

Rth={(nx+ny)/2−nz}×d (2)

In the formula, nx represents a refractive index in the in-plane slow axis direction: ny represents a refractive index in the in-plane direction perpendicular to nx; and nz represents a refractive index in the direction perpendicular to nx and ny. And “d” is a thickness of the film.

When the film to be analyzed is not expressed by a monoaxial or biaxial index ellipsoid, or that is, when the film does not have an optical axis, then Rth(λ) of the film may be calculated as follows:

Re(λ) of the film is measured around the slow axis (judged by KOBRA 21ADH or WR) as the in-plane inclination axis (rotation axis), relative to the normal direction of the film from −50 degrees up to +50 degrees at intervals of 10 degrees, in 11 points in all with a light having a wavelength of λ nm applied in the inclined direction; and based on the thus-measured retardation values, the estimated value of the mean refractive index and the inputted film thickness value. Rth(λ) of the film may be calculated by KOBRA 21ADH or WR.

In the above-described measurement, the hypothetical value of mean refractive index is available from values listed in catalogues of various optical films in Polymer Handbook (John Wiley & Sons, Inc.). Those having the mean refractive indices unknown can be measured using an Abbe refract meter. Mean refractive indices of some main optical films are listed below:

cellulose acylate (1.48), cycloolefin polymer (1.52), polycarbonate (1.59), polymethylmethacrylate (1.49) and polystyrene (1.59). KOBRA 21ADH or WR calculates nx, ny and nz, upon enter of the hypothetical values of these mean refractive indices and the film thickness. On the basis of thus-calculated nx, ny and nz, Nz=(nx−nz)/(nx−ny) is further calculated. Throughout the specification, the wavelength at the measurement is 550 nm unless otherwise specified.

### Example

The invention is described in more detail with reference to the following Examples. In the following Examples, the material used, its amount and ratio, the details of the treatment and the treatment process may be suitably modified or changed not overstepping the sprit and the scope of the invention. Accordingly, the invention should not be limitatively interpreted by the Examples mentioned below.

### Example 1

### <Synthesis of Liquid Crystalline Compound>

The liquid crystalline compounds RLC (1) and RLC (2) shown below was synthesized through a method described in paragraph [0133] of Japanese Patent Laid-Open No. Hei 6-347742.

### Liquid Crystalline Compound (RLC (1)):

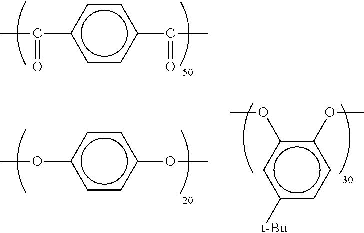

### Liquid Crystalline Compound (RLC (2)):

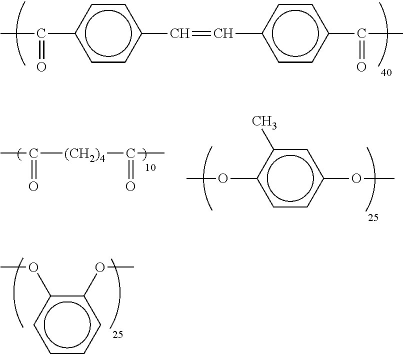

### <Production of Rodlike Liquid Crystalline Compound Layer A>

A coating solution for rodlike liquid crystalline compound layer for transfer shown below was applied onto a substrate having a polyimide film subjected to rubbing treatment in a direction of 45° relative to the film-conveying direction, followed by drying. The amount of the coating solution was controlled to produce the rodlike liquid crystalline compound layer A.

Composition of coating solution for rodlike liquid
crystalline compound layer for transfer

| | |
|---|---|
| Rodlike liquid crystalline compound (RLC (1)): | 40 parts by mass |
| Rodlike liquid crystalline compound (RLC (2)): | 80 parts by mass |
| Tetrachloroethane: | 1000 parts by mass |

### <Production of Support 1>

The compounds shown in the table below were placed into a mixing tank and were heated at 30° C. with stirring to prepare a solution of cellulose acetate.

TABLE 1

| | Inner layer | Outer layer |
|---|---|---|
| Composition of solution of | (parts by | (parts by |
| cellulose acetate | mass) | mass) |
| Cellulose acetate having | 100 | 100 |
| degree of acetyl substitution | | |
| of 2.86 | | |
| Triphenyl phosphate | 7.8 | 7.8 |
| (plasticizer) | | |
| Biphenyl diphenyl phosphate | 3.9 | 3.9 |
| (plasticizer) | | |
| Methylene chloride | 293 | 314 |
| (first solvent) | | |
| Methanol | 71 | 76 |
| (second solvent) | | |
| 1-Butanol | 1.5 | 1.6 |
| (third solvent) | | |
| Silica microparticles | 0 | 0.8 |
| (AEROSIL R972, manufactured | | |
| by Nippon Aerosil Co., Ltd.) | | |
| Retardation increasing agent | 1.7 | 0 |
| shown by Formula (2) below | | |

Retardation increasing agent Formula (2)

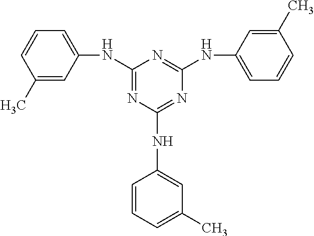 [SMILES: Cc1cccc(Nc2nc(Nc3cccc(C)c3)nc(Nc3cccc(C)c3)n2)c1]

The resulting inner layer dope and outer layer dope were casted onto a drum cooled at 0° C. from a three-layer co-casting die.

The resulting film containing 70% by mass residual solvent was peeled off from the dram, was fixed at its two sides with a pin stenter, and was dried at 80° C. while being transferred at a draw rate of 110% in the transferring direction into a residual solvent content of 10% by mass, and was then dried at 110° C.

The film was dried at 140° C. for 30 min to produce cellulose acetate film containing 0.3% by mass residual solvent (outer layer: 3 μm, inner layer: 34 μm, outer layer: 3 μm). The resulting cellulose acetate film was measured for optical properties. The resulting cellulose acetate film has a thickness of 40 μm, an Re of 5 nm, and an Rth of 40 nm.

### <Transfer of Rodlike Liquid Crystalline Compound Layer A>

An ultraviolet-curable acrylic adhesive, UV-2300 (manufactured by Toagosei Co., Ltd.), was applied onto the surface of the resulting rodlike liquid crystalline compound layer A at a thickness of 5 μm, and the support 1 was laminated thereto. The resulting laminate was irradiated with 600 mJ/cm² of UV light from the cellulose acylate film side to cure the adhesive. On this occasion, the support 1 was continuously laminated such that the absorption axis of a polarizing film defines an angle of 45° relative to the slow axis of the rodlike liquid crystalline compound layer A as illustrated in FIG. 4, to produce a retardation film.

### <Production of Polarizing Plate>

A polyvinyl alcohol (PVA) film having a thickness of 80 μm was immersed in an aqueous iodine solution having an iodine concentration of 0.05% by mass at 30° C. for 60 sec for dyeing and was than vertically stretched by five times the original length during being immersed in an aqueous boric acid solution having a boric acid concentration of 4% by mass for 60 sec, followed by drying at 50° C. for 4 min to obtain a polarizing film having a thickness of 20 μm.

A commercially available cellulose acetate film (FUJITAC T40UZ, manufactured by Fuji Film. Co., Ltd.) was immersed in an aqueous 1.5 mol/L sodium hydroxide solution at 55° C. and was then washed with water to sufficiently wash out the sodium hydroxide. Subsequently, the film was immersed in an aqueous 0.005 mol/L dilute sulfuric acid solution at 35° C. for 1 min and was then immersed in water to sufficiently wash out the aqueous dilute sulfuric acid solution. The sample was then sufficiently dried at 120° C.

The retardation film produced above and a saponified commercially available cellulose acetate film were laminated to the polarizing film with a polyvinyl alcohol adhesive so as to sandwich the polarizing film to give a polarizing plate. These films were laminated such that the rodlike liquid crystalline compound layer was outwardly disposed.

### <Production of TN Liquid Crystal Display>

A pair of polarizing plates was detached from a liquid crystal display device (AL2216W, manufactured by Acer Japan Corp.) including a TN-type liquid crystal cell, and two of the polarizing plates produced above were laminated to the apparatus on the viewer side and the backlight side, respectively, with an adhesive such that the retardation film was on the liquid crystal cell side, i.e., as shown in FIG. 2, such that the rodlike liquid crystalline compound layer was on the liquid crystal cell side. On this occasion, the polarizing plates were disposed such that the absorption axes of the polarizing plates on the viewer side and on the backlight side were orthogonal to each other.

### Other Examples and Comparative Examples

Retardation films, polarizing plate, and liquid crystal display devices of other Examples and Comparative Examples were produced as in Example 1 except that the changes shown in Table were applied.

TABLE 1

| | | | | | | | | | | Liquid |
|---|---|---|---|---|---|---|---|---|---|---|
| | | | Retardation film 23 | | | | | | | crystal cell |
| | | | Rodlike liquid crystalline compound layer 1 | | | | | | | Rubbing |
| | Angle of | | Existence or | Angle of | Formation | | | | | angle of |
| | absorption | Thickness | non- | retardation | of rodlike | | | | Type of rodlike liquid | upper |
| | mode of | at Support | existence of | (angle of | liquid | | Ra | | crystalline compound | liquid |
| | polarizing | (μm)/ | rodlike liquid | slow axis) | crystalline | Thickness | (500) | Average tilt | and amount | crystal |
| | film 21 (°) | Type | crystalline | (°) | compound | (μm) | (nm) | angle (°) | (mass ratio) | cell (°) |
| Example 1 | 0 | 40/Support1 | Existence | 45 | Transfer | 0.17 | 25 | 30 | RLC(1) 40/RLC(2) 80 | 45 |
| Example 2 | 0 | 40/Support1 | Existence | 45 | Transfer | 0.14 | 20 | 30 | RLC(1) 40/RLC(2) 80 | 45 |
| Example 3 | 0 | 40/Support1 | Existence | 45 | Transfer | 0.21 | 30 | 30 | RLC(1) 40/RLC(2) 80 | 45 |
| Example 4 | 0 | 40/Support1 | Existence | 45 | Transfer | 0.16 | 25 | 25 | RLC(1) 30/RLC(2) 70 | 45 |
| Example 5 | 0 | 40/Support1 | Existence | 45 | Transfer | 0.19 | 25 | 35 | RLC(1) 50/RLC(2) 80 | 45 |
| Example 6 | 0 | 40/Support1 | Existence | 45 | Transfer | 0.07 | 10 | 30 | RLC(1) 40/RLC(2) 80 | 45 |
| Example 7 | 0 | 40/Support1 | Existence | 45 | Transfer | 0.26 | 40 | 30 | RLC(1) 40/RLC(2) 80 | 45 |
| Example 8 | 0 | 40/Support1 | Existence | 45 | Transfer | 0.13 | 25 | 0 | RLC(1) 100 | 45 |
| | | | | | | | | (Horizontally) | | |
| Example 9 | 0 | 40/Support1 | Existence | 45 | Transfer | 0.14 | 25 | 15 | RLC(1) 15/RLC(2) 80 | 45 |
| Example 10 | 0 | 40/Support1 | Existence | 45 | Transfer | 0.15 | 25 | 20 | RLC(1) 25/RLC(2) 75 | 45 |
| Example 11 | 0 | 40/Support1 | Existence | 45 | Transfer | 0.22 | 25 | 40 | RLC(1) 30/RLC(2) 40 | 45 |
| Example 12 | 0 | 40/Support1 | Existence | 45 | Transfer | 0.84 | 25 | 50 | RLC(1) 70/RLC(2) 30 | 45 |
| Example 13 | 0 | 30/Support2 | Existence | 45 | Transfer | 0.17 | 25 | 50 | RLC(1) 40/RLC(2) 80 | 45 |
| Example 14 | 0 | 28/Support3 | Existence | 45 | Transfer | 0.17 | 25 | 30 | RLC(1) 40/RLC(2) 80 | 45 |
| Example 15 | 0 | 25/Support4 | Existence | 45 | Transfer | 0.17 | 25 | 30 | RLC(1) 40/RLC(2) 90 | 45 |
| Example 16 | 0 | 40/Support1 | Existence | 45 | Transfer | 0.24 | 25 | 30 | RLC(3) 70/RLC(4) 30 | 45 |
| Example 17 | 0 | 40/Support1 | Existence | 45 | Coating | 0.24 | 25 | 30 | RLC(3) 70/RLC(4) 20 | 45 |
| Example 18 | 0 | 40/Support1 | Existence | 35 | Transfer | 0.17 | 25 | 30 | RLC(1) 40/RLC(2) 80 | 45 |
| Example 19 | 0 | 40/Support1 | Existence | 55 | Transfer | 0.17 | 25 | 30 | RLC(1) 40/RLC(2) 80 | 45 |
| Comparative | 48 | 40/Support1 | Existence | 45 | Transfer | 0.17 | 25 | 30 | RLC(1) 40/RLC(2) 80 | 45 |
| Example 1 | | | | | | | | | | |
| Comparative | 0 | 40/Support1 | Non- | 45 | Transfer | | — | — | | 45 |
| Example 2 | | | existence | | | | | | | |
| Comparative | 0 | 40/Support1 | Existence | 45 | Transfer | 0.42 | 60 | 30 | RLC(1) 40/RLC(2) 80 | 45 |
| Example 3 | | | | | | | | | | |
| Comparative | 45 | 40/Support1 | Existence | 90 | Transfer | 0.17 | 25 | 30 | RLC(1) 40/RLC(2) 80 | 45 |
| Example 4 | | | | | | | | | | |

| | Liquid | | | | | | | | | |
|---|---|---|---|---|---|---|---|---|---|---|
| | crystal cell | Retardation film 26 | | | | | | | | |
| | Rubbing | Rodlike liquid crystalline compound layer 2 | | | | | | | | Angle of |
| | angle of | Existence or | Angle of | Formation | | | | | | absorption |
| | lower | non- | retardation | of rodlike | | | | Type of rodlike liquid | | axis of |
| | liquid | existence of | (angle of | liquid | | Ra | | crystalline compound | Thickness of | polarizing |
| | crystal cell | rodlike liquid | slow axis) | crystalline | Thickness | (500) | Average tilt | and amount | Support | film |
| | (°) | crystalline | (°) | compound | (μm) | (nm) | angle (°) | (mass ratio) | (μm/Type) | 28 (°) |
| Example 1 | −45 | Existence | −45 | Transfer | 0.17 | 25 | 30 | RLC(1) 40/RLC(2) 80 | 40/Support1 | 90 |
| Example 2 | −45 | Existence | −45 | Transfer | 0.14 | 20 | 30 | RLC(1) 40/RLC(2) 88 | 40/Support1 | 90 |
| Example 3 | −45 | Existence | −45 | Transfer | 0.21 | 30 | 30 | RLC(1) 40/RLC(2) 80 | 40/Support1 | 90 |
| Example 4 | −45 | Existence | −45 | Transfer | 0.16 | 25 | 25 | RLC(1) 30/RLC(2) 70 | 40/Support1 | 90 |
| Example 5 | −45 | Existence | −45 | Transfer | 0.19 | 25 | 35 | RLC(1) 50/RLC(2) 50 | 40/Support1 | 90 |
| Example 6 | −45 | Existence | −45 | Transfer | 0.07 | 10 | 30 | RLC(1) 43/RLC(2) 80 | 40/Support1 | 90 |
| Example 7 | −45 | Existence | −45 | Transfer | 0.28 | 40 | 30 | RLC(1) 40/RLC(2) 80 | 40/Support1 | 90 |
| Example 8 | −45 | Existence | −45 | Transfer | 0.13 | 25 | 0 | RLC(1) 100 | 40/Support1 | 90 |
| | | | | | | | (Horizontally) | | | |
| Example 9 | −45 | Existence | −45 | Transfer | 0.14 | 25 | 15 | RLC(1) 15/RLC(2) 85 | 40/Support1 | 90 |
| Example 10 | −45 | Existence | −45 | Transfer | 0.15 | 25 | 20 | RLC(1) 25/RLC(2) 75 | 40/Support1 | 90 |
| Example 11 | −45 | Existence | −45 | Transfer | 0.22 | 25 | 40 | RLC(1) 60/RLC(2) 40 | 40/Support1 | 90 |
| Example 12 | −45 | Existence | −45 | Transfer | 0.34 | 25 | 50 | RLC(1) 70/RLC(2) 30 | 40/Support1 | 90 |
| Example 13 | −45 | Existence | −45 | Transfer | 0.17 | 25 | 30 | RLC(1) 40/RLC(2) 80 | 30/Support2 | 90 |
| Example 14 | −45 | Existence | −45 | Transfer | 0.17 | 25 | 30 | RLC(1) 40/RLC(2) 80 | 28/Support3 | 90 |
| Example 15 | −45 | Existence | −45 | Transfer | 0.17 | 25 | 30 | RLC(1) 40/RLC(2) 80 | 25/Support4 | 90 |
| Example 16 | −45 | Existence | −45 | Transfer | 0.24 | 25 | 30 | RLC(8) 70/RLC(4) 30 | 40/Support1 | 90 |
| Example 17 | −45 | Existence | −45 | Coating | 0.24 | 25 | 30 | RLC(3) 40/RLC(4) 30 | 40/Support1 | 90 |
| Example 18 | −45 | Existence | −35 | Transfer | 0.17 | 25 | 30 | RLC(1) 40/RLC(2) 80 | 40/Support1 | 90 |
| Example 19 | −45 | Existence | −35 | Transfer | 0.17 | 25 | 30 | RLC(1) 40/RLC(2) 80 | 40/Support1 | 90 |
| Comparative | −45 | Existence | −45 | Transfer | 0.17 | 25 | 30 | RLC(1) 40/RLC(2) 80 | 40/Support1 | −45 |
| Example 1 | | | | | | | | | | |
| Comparative | −45 | Non- | — | Transfer | | — | — | | 40/Support1 | 90 |
| Example 2 | | existence | | | | | | | | |
| Comparative | −45 | Existence | −45 | Transfer | 0.42 | 60 | 30 | RLC(1) 40/RLC(2) 80 | 40/Support1 | 90 |
| Example 3 | | | | | | | | | | |
| Comparative | −45 | Existence | 0 | Transfer | 0.17 | 25 | 30 | RLC(1) 40/RLC(2) 60 | 40/Support1 | −45 |
| Example 4 | | | | | | | | | | |

In the table, supports 2 to 3 are produced in the same manner as the support 1 except the thickness thereof:

Support 2 having a thickness of 30 μm
Support 3 having a thickness of 25 μm
Support 4 having a thickness of 25 μm; Zeonor, manufactured by Zeon Corp.

### <Production of Retardation Film by Coating>

The retardation film of Example 17 was produced by the following process.

The support 1 was allowed to pass between dielectric heating rolls at 60° C. to increase the film surface temperature to 40° C. An alkali solution having the following composition was applied onto one surface of the film at 14 ml/m² with a bar coater. The film was retained under a far infrared steam heater (manufactured by Noritake Co., Ltd.) heated at 110° C. for 10 sec, and then pure water was applied thereto at 3 ml/m² with a bar coater. Subsequently, washing with water using a fountain coater and draining with an air knife were repeated three times, and then the film was dried in a drying zone at 70° C. for 10 sec to produce an alkali-saponified cellulose acylate film.

Composition of alkali solution

| | | |
|---|---|---|
| Potassium hydroxide: | 4.7 | parts by mass |
| Water: | 15.8 | parts by mass |
| Isopropanol: | 63.7 | parts by mass |
| Surfactant SF-1 C₁₄H₂₉O(CH₂CH₂O)₂₀H: | 1.0 | part by mass |
| Propylene glycol: | 14.8 | parts by mass |

The resulting cellulose acylate film was used as a support.

An alignment film coating solution having the following composition was continuously applied to the saponified surface of support 1 with a wire bar coater #14, followed by drying with warm wind at 60° C. for 60 sec and further with warm wind at 100° C. for 120 sec to form an alignment film.

Composition of alignment film coating solution

| | |
|---|---|
| Modified polyvinyl alcohol shown below: | 10 parts by mass |
| Water: | 371 parts by mass |
| Methanol: | 119 parts by mass |
| Photopolymerization initiator (Irgacure 2959, | 0.3 parts by mass |
| manufactured by BASF Japan Ltd.): | |

Modified polyvinyl alcohol:

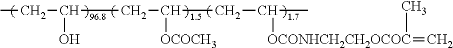

The surface of the resulting alignment film was subjected to rubbing treatment along a direction of 45° relative to the film-conveying direction.

A coating solution for rodlike liquid crystalline compound layer having the in composition was applied onto the rubbed surface of the alignment film at 4 ml/m² with a bar coater. The liquid crystalline compound was aligned by heating at an aging temperature of 90° C. for 120 sec. Subsequently, the same temperature was maintained, and the applied coating film was irradiated with UV light of an illuminance of 600 mW/cm² for 4 sec using an ultraviolet irradiation apparatus (UV lamp: output: 160 W/cm, light emission length: 1.6 m) to accelerate crosslinking to fix the liquid crystalline compound in its alignment state. Subsequently, the film was spontaneously cooled to room temperature and was wound into a cylinder to produce a rolled transfer material.

Composition of coating solution for rodlike liquid
crystalline compound layer for transfer

| | |
|---|---|
| Rodlike liquid crystalline compound (RLC (3)): | 70 parts by mass |
| Rodlike liquid crystalline compound (RLC (4)): | 30 parts by mass |

### <Synthesis of Rodlike Liquid Crystalline Compound (RLC (3))>

The rodlike liquid crystalline compound (RLC (3)) was synthesized as follows:

4-(6-Acryloyloxyhexyloxy)benzoic acid (151.3 g, 518 mmol) and 2,6-ditertiary butyl-4-methyl phenol (1.5 g) were dissolved in distilled tetrahydrofuran (180 g), and diisopropylethylamine (70.1 g, 543 mmol) was added thereto. The resulting solution was dropwise added to a solution of methanesulfonyl chloride (62.1 g, 543 mmol) in tetrahydrofuran cooled at −10° C. with stirring over 30 min. After the completion of the dropping, the reaction solution was warmed to 0° C. and was further stirred for 15 min, and a solution of methylhydroquinone (29.87 g, 246 mmol) in tetrahydrofuran was then dropwise added thereto. Subsequently, the reaction solution was stirred for 15 min, and 4-dimethylaminopyridine (3.0 g, 25 mmol) dissolved in triethylamine (62.4 g, 617 mmol) was dropwise added to the reaction solution over 15 min. After the dropping, the reaction solution was stirred at 0° C. for 1 hour and was then warmed to room temperature and stirred for 5 hours for reaction. After the completion of reaction, the reaction solution was diluted with 1000 ml of ethyl acetate and was transferred into a separatory funnel, followed by liquid-liquid extraction with 1N hydrochloric acid. The organic layer was washed with 1N hydrochloric acid, a saturated sodium hydrogen carbonate aqueous solution, and a saturated magnesium sulfate aqueous solution, in sequence. Anhydrous magnesium sulfate (100 g) was added to the organic layer. The mixture was stirred at room temperature for 1 hour for dehydration and drying. The magnesium sulfate was removed by filtration, followed by concentration with a rotary evaporator to yield a crude product of methylhydroquinone bis(4-(6-acryloyloxyhexyloxy)benzoic acid) ester. The crude product was recrystallized from ethyl acetate/methanol to yield methylhydroquinone bis(4-(6-acryloyloxyhexyloxy)benzoic acid) ester (146.9 g) as white crystals (yield: 85.2%). This compound had a purity of 98.7% measured by gel permeation chromatography (GPC). The GPC was performed using tetrahydrofuran as an elution solvent with a GPC analyzer, CCP & 8000 (CP-8000, CO-8000, UV-8000) manufactured by Tosoh Corporation equipped with column (TSKgelG-1000HXL) for high-performance GPC. The compound was observed using a Mettler hot Stage under a polarizing microscope. A liquid crystal phase was observed at room temperature and was changed to a nematic liquid crystal phase at about 85° C. and to an isotropic phase at about 115° C. during a heating process.

### <Synthesis of Rodlike Liquid Crystalline Compound (RLC (4))>

Liquid crystalline compound (RLC (4)) was synthesized as in liquid crystalline compound (RLC (3)) except that 4-(6-acryloyloxyhexyloxy)benzoic acid (32.5 g, 111 mmol) and 4-cyanophenol (12.6 g, 106 mmol) were used to give 34.8 g of 4-cyanophenol 4-(6-acryloyloxyhexyloxy)benzoic acid) ester (yield: 84%). The compound had a purity of 99.3% measured by GPC.

### <Evaluation>

### (Yield of Polarizing Plate)

A film was cut out from a polarizing plate in a rolled state, and the ratio of the area of the film excluding unnecessary region to the total area of the film was calculated.

### (Brightness in White Display Mode)

The polarizing plate was disposed on the backlight under an atmosphere of a temperature of 25° C. and a relative humidity of 60%, and the white luminance in a state of not applying any voltage to the TN liquid crystal cell was measured with luminance meter (BM-5A, manufactured by Topcon Technohouse Corp.) installed at the front of the display face.

Each polarizing film was disposed such that the transmission axis is parallel to the alignment direction of the liquid crystalline compounds in the surface of the liquid crystal cell at the side close to the polarizing film (optical rotation mode), and the brightness was measured. The results are shown as relative evaluation compared to the brightness in a white display mode using the same polarizing plate that is defined as 100.

### (Lower Gray Scale Inversion)

Each liquid crystal display device was evaluated by measuring the viewing angle at the lower azimuth with a measuring machine “EZ-Contrast XL88” (manufactured by ELDIM).

### <Evaluation>

A: no gradation inversion and black crushing were found
B: no gradation inversion was found, but black crushing was found
C: grayscale inversion was found

### (Viewing Angle Contrast)

The brightness in a white mode (Yw) seen from a position of a polar angle of 40° and the brightness in a black mode (Yb) seen from a position of a polar angle of 40° were measured to determine a contrast ratio of Yw to Yb with a measuring device “EX Contrast XL88” (manufactured by ELDIM), and were evaluated by the following criteria:

A: Average contrast in the vertical and horizontal directions from a position of a polar angle of 40° of 20 or more
B: Average contrast in the vertical and horizontal directions from a position of a polar angle of 40° of 10 or more but less than 20
C: Average contrast in the vertical and horizontal directions from a position of a polar angle of 40° of less than 10

### (Alignment Defect)

Alignment defects were visually observed with a polarizing microscope.

None: no alignment defect was found

Found: countless fine alignment defects were found.

### [Power Consumption]

The table below shows the power consumption of the brightness of which the brightness was controlled so as to be equivalent to the white brightness of Example 1.

TABLE 3

| | Yield of viewer side | | | | | |
|---|---|---|---|---|---|---|
| | and backlight side | Brightness | | Lower | View | |
| | polarizing plate | in white | Power | grayscale | angle | Alignment |
| | 23 inch panel | display mode | consumption | inversion | contrast | defect |
| Example 1 | 79%/89% | 100 | 1.00 | A | A | None |
| Example 2 | 79%/89% | 100 | 1.00 | A | A | None |
| Example 3 | 79%/89% | 100 | 1.00 | A | A | None |
| Example 4 | 79%/89% | 100 | 1.00 | A | A | None |
| Example 5 | 79%/89% | 100 | 1.00 | A | A | None |
| Example 6 | 79%/89% | 96 | 1.04 | A | A | None |
| Example 7 | 79%/89% | 95 | 1.05 | A | B | None |
| Example 8 | 79%/89% | 100 | 1.00 | C | C | None |
| Example 9 | 79%/89% | 100 | 1.00 | C | C | None |
| Example 10 | 79%/89% | 100 | 1.00 | C | B | None |
| Example 11 | 79%/89% | 100 | 1.00 | B | A | None |
| Example 12 | 79%/89% | 100 | 1.00 | B | A | None |
| Example 13 | 79%/89% | 100 | 1.00 | A | A | None |
| Example 14 | 79%/89% | 100 | 1.00 | A | A | None |
| Example 15 | 79%/89% | 100 | 1.00 | A | A | None |
| Example 16 | 79%/89% | 100 | 1.00 | A | A | None |
| Example 17 | 79%/89% | 100 | 1.00 | A | A | Found |
| Example 18 | 79%/89% | 100 | 1.00 | A | A | None |
| Example 19 | 79%/89% | 100 | 1.00 | A | A | None |
| Comparative | 86%/86% | 100 | 1.00 | A | A | None |
| Example 1 | | | | | | |
| Comparative | 79%/89% | 91 | 1.10 | A | A | — |
| Example 2 | | | | | | |
| Comparative | 79%/89% | 83 | 1.20 | D | B | None |
| Example 3 | | | | | | |
| Comparative | 86%/86% | 91 | 1.10 | A | C | None |
| Example 4 | | | | | | |

The table demonstrates that Examples 1 to 19 show low power consumption and high yield of the polarizing plate. In addition, the hybrid alignment of the rodlike liquid crystalline compound inhibited the lower grayscale inversion from occurring and increased the viewing angle contrast. This tendency was notable in an average tilt angle range of 20° to 40°.

Comparative Examples 1 and 4 not being of a birefringence mode exhibit insufficient lower grayscale inversion and low cutting out yields of the polarizing plates.

Comparative Example 2 including no rodlike liquid crystalline layer exhibits suppressed lower grayscale inversion and high yield of the polarizing plate, but high power consumption.

Comparative Example 3 showing low brightness in a white display mode exhibits power consumption higher than those in Examples. In addition, Example 17 demonstrates that the transfer of a rodlike liquid crystalline compound layer can inhibit alignment defects.

The present disclosure relates to the subject matter contained in Japanese Patent Application Nos. 215992/2012, filed on Sep. 28, 2012 and 179006/2013, filed on Aug. 30, 2013, which are expressly incorporated herein by reference in their entirety. All the publications referred to in the present specification are also expressly incorporated herein by reference in their entirety.

The foregoing description of preferred embodiments of the invention has been presented for purposes of illustration and description, and is not intended to be exhaustive or to limit the invention to the precise form disclosed. The description was selected to best explain the principles of the invention and their practical application to enable others skilled in the art to best utilize the invention in various embodiments and various modifications as are suited to the particular use contemplated. It is intended that the scope of the invention not be limited by the specification, but be defined claims set forth below.

1. A retardation film comprising:
a support (A); and
a rodlike liquid crystalline compound layer (B), when two polarizing plates each having the retardation film as a polarizing plate protective film are incorporated into a liquid crystal display device having a TN liquid crystal cell so as to dispose the liquid crystal cell between the polarizing plates, wherein the polarizing plates are arranged such that the retardation films are arranged at the side close to the liquid crystal cell, that the absorption axes of the polarizing plates are orthogonal to each other, that the absorption axis of each polarizing film defines an angle of approximately 45° relative to the alignment direction of the liquid crystalline compounds on the surface of the liquid crystal cell at the closer side, that the slow axis of the rodlike liquid crystalline compound layer defines an angle of 45° relative to the absorption axis of the polarizing film, and that the alignment direction of the liquid crystalline compounds defines an angle of 170° to 190° relative to the slow axis of the rodlike liquid crystalline compound layer,
the brightness in a white display mode is 95% or more of the brightness when the polarizing plates are arranged in the liquid crystal display such that the transmission axis of each polarizing film is parallel to the alignment direction of the liquid crystalline compounds on the surface of the liquid crystal cell at the closer side.

2. The retardation film according to claim 1, wherein the rodlike liquid crystalline compound layer has a retardation in plane (Re(550)) satisfying 10 nm≦Re(550)≦40 nm at a wavelength of 550 nm.

3. The retardation film according to claim 1, wherein the rodlike liquid crystalline compounds in the rodlike liquid crystalline compound layer are hybrid-aligned.

4. The retardation film according to claim 3, wherein the rodlike liquid crystalline compounds have an average tilt angle within a range of 20°≦average tilt angle≦40°.

5. The retardation film according to claim 1, wherein the support has a thickness of 40 μm or less.

6. The retardation film according to claim 1, wherein the support has a thickness of 25 μm or less.

7. The retardation film according to claim 1, wherein the support is a cellulose acylate film or a cycloolefin polymer film.

8. The retardation film according to claim 1, wherein the rodlike liquid crystalline compound is a rodlike liquid crystalline high-molecular compound.

9. The retardation film according to claim 1, wherein the rodlike liquid or compound is a polymerizable liquid crystalline compound.

10. The retardation film according to claim 1, wherein the rodlike liquid crystalline compound layer is prepared by transferring a rodlike liquid crystalline compound layer formed on a tentative support onto the support.

11. The retardation film according to claim 1, wherein the slow axis of the rodlike liquid crystalline compound layer and the slow axis of the support define an angle of 35° to 55°

12. A polarizing plate comprising the retardation film according to claim 1 and a polarizing film.

13. A polarizing plate according to claim 12, wherein the slow axis of the support is approximately parallel to the absorption axis of the polarizing film.

14. A polarizing plate according to claim 13, wherein the polarizing plate is produced by roll-to-roll.

15. A TN liquid crystal display device comprising a retardation film according to claim 1.

16. A TN liquid crystal display device comprising a polarizing plate according to claim 13.

17. A TN crystal display, wherein a polarizing plate according to claim 12 is disposed such that the absorption axis of the polarizing film defines an angle of approximately 45° relative to the alignment direction of the liquid crystalline compounds on the surface of the liquid crystal cell of a TN mode at the side close to the polarizing film.

18. A method of producing a retardation film according to claim 1, the method comprising:
forming a rodlike liquid crystalline compound layer on a tentative support; and
transferring the rodlike liquid crystalline compound layer onto a support having a thickness of 40 μm or less.

19. A method of producing a retardation film according to claim 1, the method comprising:
laminating a support and a rodlike liquid crystalline compound layer by roll-to-roll such that the slow axis of the support and the absorption axis of the polarizing film are approximately parallel to each other and that the slow axis of the rodlike liquid crystalline compound layer and the slow axis of the support define an angle of 35° to 55°.
